(19) United States
(12) Patent Application Publication
(10) Pub. No.: US 2013/0018692 A1
(43) Pub. Date: Jan. 17, 2013

(54) APPARATUS, METHOD, AND COMPUTER PROGRAM PRODUCT FOR SCENARIO-BASED IDENTIFICATION OF COMPLETE SAFETY-BASED REQUIREMENTS SPECIFICATION

(71) Applicants: Zhensheng Guo, Erlangen (DE); Peter Liggesmeyer, Kaiserslautern (DE)

(72) Inventors: Zhensheng Guo, Erlangen (DE); Peter Liggesmeyer, Kaiserslautern (DE)

(73) Assignee: Siemens Aktiengesellschaft, Munchen (DE)

(21) Appl. No.: 13/181,681

(22) Filed: Jul. 13, 2011

(51) Int. Cl. G06Q 10/06

(52) U.S. Cl. 705/7.25

(57) ABSTRACT

A method for defining a safety-oriented requirements specification for a technical system completely and concurrently, has: carrying out a safety based specification identification process, performing a sequence based qualitative risk analysis to identify a plurality of safety critical states, partially eliminating safety critical states from identified critical states, recording a plurality of safety critical requirements by a system state machine, creating a reduced state machine based on technical system functional requirements and the recorded requirements, finding a plurality of failure modes and first countermeasures, finding data deviations and second countermeasures, finding failure modes and corresponding corrective actions with respect to a technical system interface, displaying information regarding the identified plurality of failure modes, performing a quantitative safety analysis regarding the technical system, identifying a plurality of risk values, and prioritizing functions in the safety-oriented requirements specification for a technical system according to the identified plurality of risk values.

### CROSS-REFERENCE TO RELATED APPLICATIONS

This application claims the benefit of U.S. Provisional Application No. 61/382,100 filed Sep. 13, 2010, the entire contents of which are hereby incorporated in their entirety by reference.

### TECHNICAL FIELD

The present invention is directed to an apparatus, a method, and a computer program product for scenario based identification of a safety-based requirements specification for a technical system. In particular, the present invention is directed to means and methods that facilitate the exhaustive identification of both functional and safety requirements for a system, in the same requirements specification.

### BACKGROUND

While attempting to completely describe safety-critical, and software-intensive technical systems, it is very important to identify risks early, and if possible the description of the safety based requirements of such technical systems should lead to the sufficient and proactive handing of these risks.

Risks, that are introduced during the early development phase of a technical system, may be eliminated in latter phases only at considerable costs or they may remain hidden until an accident occurs during the operation of the system. Further, fundamental system requirements that are not fulfilled or design errors, such as the incomplete definition of system requirements, can lead to fatal accidents.

Requirements analysis techniques are used already during the early development phases of a technical system in order to prevent or entirely avoid risks, if possible early during the requirements engineering phases of the technical system. The traditional, known requirements gathering techniques focus not on the identification of risks, but on the identification of functional requirements for the technical system under development, and on the completeness of the functional requirements. The functional requirements are traditionally presented in the form of specifications, which describe the desired functionality the technical system to be built is to have. Safety-critical requirements, which refer for example to non-expected behaviors, are not typically observed and taken into account in the specification when the functional requirements of a technical system are developed. As a result, safety-critical systems and their requirements are often not sufficiently specified.

Therefore, it is desirable to have methods and means capable of taking into consideration all potential behaviors of a technical system to be developed, including the system behavior during the occasions when the respective system does not perform properly.

In particular for safety-critical software-intensive technical systems only the desired requirements comprised in a development request are identified during the phase of software engineering. The so called “non-desirable” requirements are not indentified in most cases till a much latter phase. Typically, the desired requirements and the non-desired requirements are identified by two separate technical groups. For example, the desired requirements of the system are identified by the requirements engineers and the unwanted requirements are indentified by safety experts. The understanding the requirements engineers have and the safety experts have regarding the system being developed is not always identical. As a result, safety gaps may occur, since the desired requirements are not associated with the user demands and further, requirements gaps may occur since the desired safety features are not associated with the desired system requirements. This is due to the fact that most times these groups work separately. In addition, necessary information that needs to be documented explicitly, such as assumptions and conditions, is unfortunately treated as implicit information. As a result, the non-desired requirements (safety-critical requirements) for a system are identified in an unpredictable manner based on an incomplete set of desired requirements. Furthermore, the non-desired requirements (safety-critical requirements) for a system are not systematically identified.

Two types of methods are currently known in the art for the concurrent identification of functional requirements and safety requirements for a technical system. The first starts by identifying functional requirements and continues with performing a safety analysis, such as a Fault Tree Analysis, in order to identify non-expected system behavior, but fails to consider the completeness of the gathered safety requirements. The second focuses on identifying the safety requirements with the help of one or several safety analysis techniques, condition based completeness check criteria and even formal techniques, but fails to take into account the completeness of the functional requirements.

A gap, both theoretical and practical, may be identified between the complete functional requirements and complete safety requirements of the system.

In summary, no currently available technology provides for the complete identification of the desired requirements of the system and for the complete identification of the unwanted requirements of the technical system at the same time.

### SUMMARY

According to an embodiment, an apparatus for providing a structure defining a safety-oriented requirements specification for a technical system, may comprise means for gathering information regarding a plurality of elements characteristics of the technical system, and means for applying a grammar, wherein the grammar is capable of defining syntactically the structure based on the plurality of elements characteristics of the technical system, and wherein the grammar is capable of refining syntactically the safety-oriented requirements specification for the technical system.

According to a further embodiment, the technical system may comprise both a plurality of functional characteristics and a plurality of safety requirements for the technical system. According to a further embodiment, the technical system may comprise at least one of technical system goals, technical system scenarios, technical system requirements, and technical system safety requirements. According to a further embodiment, the technical system goals may comprise both a plurality of functional goals and a plurality of non functional goals. According to a further embodiment, the technical system scenarios may comprise either one of a plurality of positive scenarios, a plurality of negative scenarios, and a plurality of alternative scenarios. According to a further embodiment, for the development of the plurality of positive scenarios, a plurality of negative scenarios and a plurality of alternative scenarios both functional and safety requirements may be included. According to a further embodiment, the technical system requirements may comprise at least one of technical system functional requirements, technical system data requirements, technical system interface requirements, technical system non-functional requirements, and assumptions regarding the technical system. According to a further embodiment, the technical system safety requirements may comprise at least one of a plurality of hazards, a plurality of causes, a plurality of impacts, a plurality of effects, and a safety integrity level. According to a further embodiment, the plurality of hazards can be derived at least from one of information provided regarding the technical system, the state of the technical system, and a condition of the technical system.

According to another embodiment, a method for providing a structure defining a safety-oriented requirements specification for a technical system, may comprise gathering information regarding a plurality of elements characteristics of the technical system, and applying a grammar, wherein the grammar is capable of defining syntactically the structure based on the plurality of elements characteristics of the technical system, and wherein the grammar is capable of refining syntactically the safety-oriented requirements specification for the technical system.

According to yet another embodiment, a method for providing a safety-oriented requirements specification for a technical system, may comprise carrying out a safety based specification identification process for the technical system; performing a sequence based qualitative risk analysis to identify a plurality of safety critical states for the technical system; partially eliminating safety critical states of the identified plurality of safety critical states or safety critical transitions; recording a plurality of safety critical requirements for the technical system by a system state machine; creating a reduced state machine based on a plurality of technical system functional requirements and the recorded plurality of safety critical requirements;

finding a plurality of failure modes and a first plurality of countermeasures; finding a plurality of data deviations and a second plurality of countermeasures; finding a plurality of failure modes and a plurality of corresponding corrective actions with respect to a technical system interface; displaying information regarding the identified plurality of failure modes; performing a quantitative safety analysis regarding the technical system; identifying a plurality of risk values, and prioritizing functions in the safety-oriented requirements specification for a technical system according to the identified plurality of risk values.

According to a further embodiment of the above method, the step of performing sequence based qualitative risk analysis may comprises at least one of performing sequence based risk analysis, performing the identification of safety critical sequences, performing the identification of counter measures, and the generation of state machines. According to a further embodiment of the above method, the step of finding a plurality of failure modes and a plurality of corresponding corrective actions with respect to a system interface can be carried out by exporting the identified plurality of functional requirements to an C-FMEA editor.

According to yet another embodiment, a computer program product may comprise a tangible computer usable medium including a computer usable program code for providing a safety-oriented requirements specification for a technical system, the computer usable program code for: carrying out a safety based specification identification process for the technical system; performing a sequence based qualitative risk analysis to identify a plurality of safety critical states for the technical system; partially eliminating safety critical states of the identified plurality of safety critical states; recording a plurality of safety critical requirements for the technical system by a system state machine; creating a reduced state machine based on a plurality of technical system functional requirements and the recorded plurality of safety critical requirements;

finding a plurality of failure modes and a first plurality of countermeasures; finding a plurality of data deviations and a second plurality of countermeasures; finding a plurality of failure modes and a plurality of corresponding corrective actions with respect to a technical system interface; displaying information regarding the identified plurality of failure modes; performing a quantitative safety analysis regarding the technical system; identifying a plurality of risk values, and prioritizing functions in the safety-oriented requirements specification for a technical system according to the identified plurality of risk values.

According to yet another embodiment, an apparatus can be adapted to perform the method as described above.

### BRIEF DESCRIPTION OF THE DRAWINGS

In order to assist the understanding of embodiments, reference will now be made to the appended drawings, in which like reference numerals refer to like elements. The drawings are exemplary only, and should not be construed as limiting the invention.

FIG. 1 is a representation of an extended version of a grammar Backus-Naur form;

FIG. 2 is a representation of a correlation between system requirement types and safety analysis techniques;

FIG. 3 is a structure for defining a safety-oriented requirements specification for a technical system;

FIG. 4 is a schematic representation of a flow chart of a SafeSBS (safety oriented sequence based specification).

FIG. 5 is a flowchart representation of a method in accordance with an embodiment, for obtaining a safety-oriented requirements specification for a technical system; and

FIG. 6 is an alternative graphical representation of a workflow for obtaining a safety-oriented requirements specification for a technical system.

The accompanying drawings are included to provide a further understanding of various embodiments. The drawings illustrate embodiments and together with the description serve to explain the principles of the embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts. Features of the various exemplary embodiments described herein may be readily combined with each other, unless specifically noted otherwise.

### DETAILED DESCRIPTION

According to various embodiments, an apparatus for providing a structure defining a safety-oriented requirements specification for a technical system may comprise means for gathering information regarding a plurality of elements characteristics of the technical system, and means for applying a grammar, wherein the grammar is capable of defining syntactically the structure based on the plurality of elements characteristics of the technical system, and wherein the grammar is capable of refining syntactically the safety-oriented requirements specification for the technical system.

In accordance with various embodiments the technical system comprises both a plurality of functional characteristics and a plurality of safety requirements the technical system are identified.

The technical system can comprise at least one of technical system goals, technical system scenarios, technical system requirements, and technical system safety requirements.

The technical system goals can comprise in a possible embodiment both a plurality of functional goals and a plurality of non functional goals.

The technical system scenarios can comprise in possible embodiments either one of a plurality of positive scenarios, a plurality of negative scenarios, and a plurality of alternative scenarios.

For the development of the plurality of positive scenarios, the plurality of negative scenarios and the plurality of alternative scenarios, both functional and safety requirements are identified.

The technical system requirements can comprise at least one of technical system functional requirements, technical system data requirements, technical system interface requirements, technical system non-functional requirements, and assumptions regarding the technical system.

The technical system safety requirements can comprise at least one of a plurality of hazards, a plurality of causes, a plurality of impacts, a plurality of effects, and a safety integrity level (SIL).

The plurality of hazards is derived at least from one of behavior description provided regarding the technical system, the state of the technical system, and a condition of the technical system.

According to other embodiments, a method for providing a structure defining a safety-oriented requirements specification for a technical system, may comprise gathering information regarding a plurality of elements characteristics of the technical system, and applying a grammar. The grammar is capable of defining syntactically the structure based on the plurality of elements characteristics of the technical system, and is capable of refining syntactically the safety-oriented requirements specification for the technical system.

According to yet further embodiments, a method for providing a safety-oriented requirements specification for a technical system, may comprise carrying out a safety based specification identification process for the technical system, at first, performing a sequence based qualitative risk analysis to identify a plurality of safety critical states for the technical system, partially eliminating safety critical states of the identified plurality of safety critical states, recording and representing a plurality of safety critical requirements for the technical system by constructing a system state machine, creating a reduced state machine based on a plurality of technical system functional requirements and the recorded plurality of safety critical requirements, finding a plurality of failure modes and a first plurality of countermeasures, finding a plurality of data deviations and a second plurality of countermeasures, finding a plurality of failure modes and a plurality of corresponding corrective actions with respect to a technical system interface, displaying information regarding the identified plurality of failure modes; secondly, performing a quantitative safety analysis regarding the technical system, identifying a plurality of risk values, and prioritizing functions in the safety-oriented requirements specification for a technical system according to the identified plurality of risk values.

The method for defining a safety-oriented requirements specification for a technical system according to various embodiments comprises the step of performing sequence based qualitative risk analysis, step that can comprise at least one of performing sequence based hazard analysis, performing the identification of safety critical sequences, performing the identification of counter measures, and the generation of state machines. The step of finding a plurality of failure modes and a plurality of corresponding corrective actions with respect to a system interface is carried out by exporting the identified plurality of functional requirements to an C-FMEA interface editor.

According to yet other embodiments, a computer program product may comprise a tangible computer usable medium including a computer usable program code for providing a safety-oriented requirements specification for a technical system, the computer usable program code for carrying out a safety based specification identification process for the technical system, performing a sequence based qualitative risk analysis to identify a plurality of safety critical states for the technical system, partially eliminating safety critical states of the identified plurality of safety critical states, recording a plurality of safety critical requirements for the technical system by a system state machine, creating a reduced state machine based on a plurality of technical system functional requirements and the recorded plurality of safety critical requirements, finding a plurality of failure modes and a first plurality of countermeasures, finding a plurality of data deviations and a second plurality of countermeasures, finding a plurality of failure modes and a plurality of corresponding corrective actions with respect to a technical system interface, displaying information regarding the identified plurality of failure modes, performing a quantitative safety analysis regarding the technical system, identifying a plurality of risk values, and prioritizing functions in the safety-oriented requirements specification for a technical system according to the identified plurality of risk values.

According to yet other embodiments, an apparatus can be adapted to perform the above referenced method for providing a safety-oriented requirements specification for a technical system.

In this description, reference is made to “predicates”. In accordance with the meaning associated in the present document, predicates represent relations between variables, properties, etc., wherein the variables and properties, in turn, may pertain in various ways to the instrumented program being analyzed.

By “complete” and/or “completeness” in accordance with various embodiments are understood both the completeness of description in the specification regarding its requirements of a single requirement of the technical system and the completeness of description regarding its requirements of all possible requirements of the technical system.

A complete set of all possible requirements of the technical system with fully described individual requirements, constitutes the desired completeness of the requirements. In order to achieve the desired completeness, a definition of all safety-based requirements is required for the technical system.

In order to identify completely the safety-oriented, or safety based, requirements of a technical system, at least the following are required:

a structure and its corresponding grammar that defines and accommodates both functional and safety requirements;
a technique that is used to completely identify the functional requirements of the technical system;
a systematic safety analysis for identifying the corresponding safety requirements based on the identified complete functional requirements, and
the specification of the functional and safety requirements in one document, if possible, in an intuitive way.

The means and techniques of various embodiments are used, in addition for the complete identification of desirable functions or desirable requirements of a technical system, including the non-desired requirements (safety-critical requirements), also to identify the complete requirements of safety-critical systems.

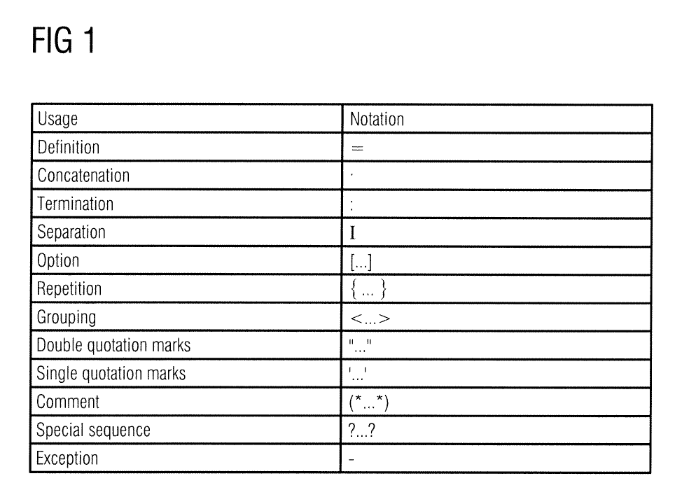

For the complete identification of the safety-oriented requirements of a technical system, comprising both desirable and undesirable requirements, for example a grammar similar to the Backus-Naur form may be used. An embodiment of an extended version of a grammar Backus-Naur form, that is proposed in accordance with various embodiments, is represented in FIG. 1.

As it will be apparent to a person skilled in the art of computer science, by Backus-Naur Form is understood a notation technique for context-free grammars, often used to describe the syntax of languages used in computing, such as computer programming languages, document formats, instruction sets and communication protocols. It is applied wherever exact descriptions of languages is needed, for instance, in official language specifications, in manuals, and in textbooks on programming language theory.

The above referenced grammar is capable of defining syntactically a structure of safety-oriented requirements for a technical system based on a plurality of elements characteristics for the technical system, and is further capable of refining syntactically the safety oriented requirements specification for the technical system.

The plurality of elements characteristic for the technical system may exemplarily comprise all of the following elements, i.e. elements that will be employed, as it will be shown in the following, for creating a structure for defining a safety-oriented requirements specification for a system. Exemplarily, the plurality of elements characteristics for a system may comprise: the safety requirements such as goal, scenario, requirement and hazard, scenarios that may be a positive scenario, a negative scenario, and an alternative scenario, requirements, such as function, data, interface, quality requirements, safety requirements, the safety requirements comprising negative requirements, negated requirements, hazards, wherein hazards may include failure mode, failure cause, failure impact, countermeasures, SIL or ASIL (Automotive safety integrity level), function that may be an identifier, item, behavior, data that may comprise input data or output data, conditions such as environmental conditions, driving conditions, operational conditions, as defined by various standards, failure reasons, such as failure class, and failure reason, wherein the failure class may be omission, commission, timing, and the failure reason, wherein by reason is further understood a function malfunction, a malfunction of other functions, hazardous sequences, and data deviation, SIL such as risk, or priority, environmental conditions such as weather conditions and road conditions, risk, such as probability severity.

It is of note that in accordance with various embodiments, it is assumed that by “goal” is understood a system goal. A goal describes why a system is being developed, or has been developed, from the point of view of the business, organization or the system itself. In order to completely identify a goal, both functional goals (expected services of the system) and non-functional goals (quality of service, constraints on the design, etc.) can be determined.

A goal model may be built as a directed graph by means of a refinement from the systems goals (or concerns). This refinement lasts until goals have enough granularity and detail so as to be assigned to an agent (software or environment) so that they are verifiable within the system-to-be. This refinement process is performed by using AND/OR/XOR refinement relationships. In addition, operationalizations are also specified during the goal model definition.

Operationalizations are the lowest level refinements introduced to describe the design alternatives associated to the requirements by means of contribution relationships.

In accordance with various embodiments it is assumed that non-hazardous conditions are indeed non-hazardous. Further, via constraints in various embodiments are understood system limits and ranges that aid in the identification of potentially hazardous situations. By input is understood an input sequence, including input data and commands and stimuli, and via an output may be understood a response.

The extended version of the grammar proposed by various embodiments in FIG. 1 defines syntactically the structure employed for defining the safety-oriented requirements specification for the technical system, and may perform the following exemplary refinements of the plurality of elements characteristics for the system who's safety oriented requirements specification are intended to be obtained:

| | |
|---|---|
| SafeRequirements = | Goal, Scenario, Requirement, Hazard; |
| Scenarios = | Positive scenario I Negative scenario I |
| | Alternative scenario; |
| Requirement = | Function I Data I Interface I Quality |
| | Requirements I Safety Requirement; |
| Safety | Negative Requirements I Negated Requirements |
| Requirement = | I Hazards; |
| Hazard = | Failure mode, (Assumption, Condition, |
| | Constrains), Failure cause, Failure compact, |
| | Countermeasures effect, SIL I [ASIL] |
| Function = | Identifier I Item I Behavior; |
| Data = | Input I Output; |
| Condition = | Environmental condition, Driving condition, |
| | Operational condition; |
| Failure reason = | Failure class I Failure_reason: |
| Or_Reason = | And_Reason {IAnd_Reason}I?And_Reason |
| | {IAnd_Reason=? |
| Reason = | Function malfunction I Malf. Of other |
| | functions I hazardous sequences I Data |
| | Deviation; |
| SIL = | Risk I Priority I SIL; |
| Environmental | Weather condition, road condition, . . . ; |
| Conditions = | |
| Risk = | Probability, Severity; |

As can be seen in the above, there are at least four main parts of functional requirements: function, data, interface, and non-functional requirements. Non-functional requirements will not be implemented in this context because of the complexity of the involved quality attributes such as performance, availability, and so on and will not be included in the present document. This by no means does intend to specify that the non-functional requirements may not be implemented via the means proposed by various embodiments.

The functional, data and interface requirements of the technical system are thus considered as main elements for the functional requirements of the technical system. For identifying these requirements based on such types, a sequence-based specification is one suitable technique that complies with the structure of the desired functional requirements. This approach ensures the completeness of the functional requirements in the sense of functional, data, and interface specification through enumeration of all possible sequences.

That is, the complete safety-oriented requirements specification includes the elements that are defined in the structure. The structure defines the data model for an extended SBS-editor, which will be described in connection with the following embodiments. SBS stands for sequence-based specification.

A sequence based specification, SBS, is a widespread technique used to characterize software intensive embedded systems. Because of the systematic process used in SBS correct and complete specifications will be developed for the studied system. The SBSs available in the art however deal only with legal and illegal system states, and do not provide a way to detect or consider safety-critical hazardous states systematically. Therefore there is a need for an extended SBS editor, having a data model which is described by the structure proposed in accordance with various embodiments.

SBS is a requirements identification technology (including requirements analysis and requirement specification), which serves to identify in full the desired function or to identify in full the desired requirements. In accordance with the present the SBS is extended to an extended SBS, which is used in addition to identifying the desired functions and desirable requirements, also for identifying the safety-critical unwanted requirements for the system.

Therefore, the various embodiments provide a technique that can identify simultaneously and completely the desired and undesired system requirements. The above mentioned sequence-based specification (SBS) offers the possibility to identify fully the desired requirements, and to identify the unwanted demands, as will be shown in connection with the embodiments, in connection with the extended SBS-editor.

The full identification of the desired requirements of a technical system, and the identification of the unwanted demands by the extended SBS editor may be realized, in accordance with the embodiments, by incorporating additional features in the SBS-editor, such as by providing a safety-critical column in the sequence enumeration (“sequence enumeration”) of the SBS, by importing in conditions and assumptions in the Sequence numeration, and providing three additional editors, etc. The aforementioned sequence enumeration is used in the SBS to represent the desired system behavior with the SBS-editor.

This can be done in Black box specifications format, when employing an HTML-based specification, and in a State box format, when employing for the characterization of the states of the technical system a state machine.

By state machine is understood any device that stores the status of something at a given time and that can operate on input to change the status and/or cause an action or output to take place for any given change. A computer is basically a state machine and each machine instruction is input that changes one or more states and may cause other actions to take place. Each computer's data register stores a state. The read-only memory from which a program is loaded stores a state (the boot program itself is an initial state). The operating system is itself a state and each application that runs begins with some initial state that may change as it begins to handle input. Thus, at any moment in time, a computer system can be seen as a very complex set of states and each program in it as a state machine. In practice, however, state machines are used to develop and describe specific device or program interactions.

To summarize, a state machine can be described as an initial state or record of something stored someplace, a set of possible input events, a set of new states that may result from the input, a set of possible actions or output events that result in a new state. In their book “Real-time Object-oriented Modeling”, Bran Selic & Garth Gullekson view a state machine as: a set of input events, a set of output events, a set of states, a function that maps states and input to output, a function that maps states and inputs to states (which is called a state transition function) and a description of the initial state.

A finite state machine is a state machine that has a limited or finite number of possible states. A finite state machine can be used both as a development tool for approaching and solving problems and as a formal way of describing the solution for later developers and system maintainers. There are a number of ways to show state machines, from simple tables through graphically animated illustrations.

The above mentioned extended SBS editor identifies hazards by performing risk analysis techniques.

In principle, at least two types of non-desired requirements are identified, namely negative requirements and requirements negated. Negative requirements describe what the system should not do to ensure the safety of the system (such as not hurting anyone). Negated requirements describe what is to do by the system to keep the system safe if the desired requirements cannot be met (that is, when mistakes happen).

The safety requirements are essentially counter-measures of all possible hazards. Or, in other words, the safety requirements are countermeasures for the negated negative requirements.

However, in order to identify the negated requirements, first negative requirements need to be identified.

To completely identify such requirements in a safety based requirements specification, both negative and negated, all possible hazards should be first identified.

In order to identify all hazards, appropriate risk analysis techniques, such the use of an extended SBS-editor, are proposed to be used. The selection of appropriate risk analysis techniques is based on the type of desired functional requirements.

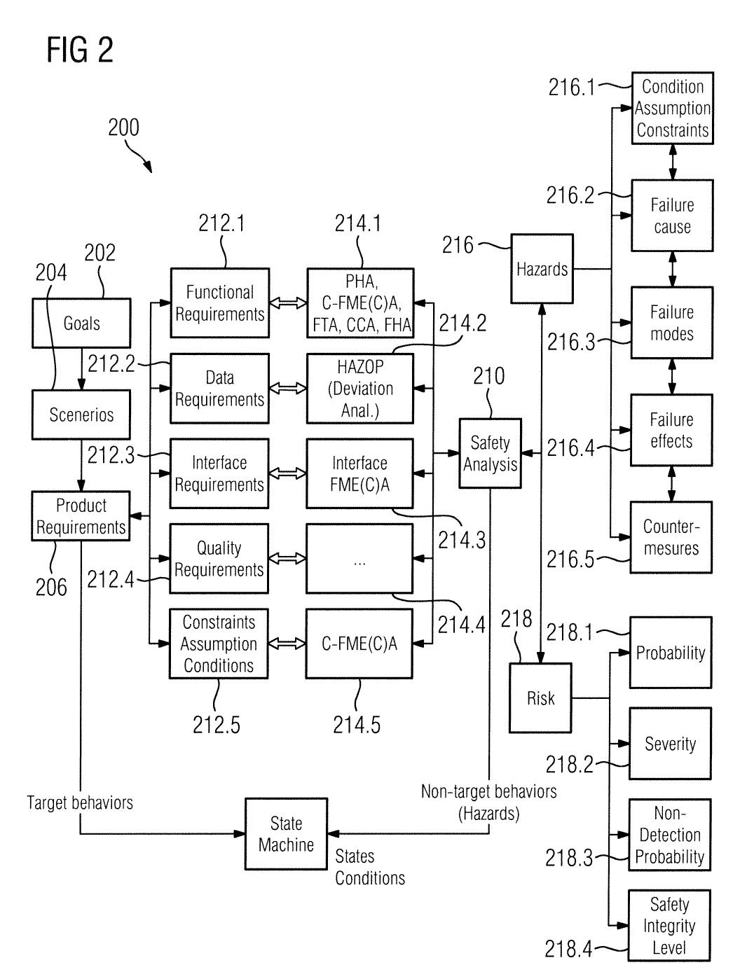

In the following, mapping of different risk analysis techniques for different components of the functional requirements is presented. Exemplarily, such mapping is illustrated in FIG. 2.

FIG. 2 is a representation of a correlation between system requirements types and safety analysis techniques.

As illustrated in FIG. 2 a system 200, in particular a technical system or a software intensive system, may be characterized via goals 202, scenarios 204, product requirements 206, a state machine 208 and safety analysis 210. The product requirements 206 are at least functions requirements 212.1, data requirements 212.2, interface requirements 212.3, quality requirements 212.4 and constrains, assumption, conditions 212.4. A plurality of techniques that assess the possibility of failure of the product requirements 206 are offered exemplarily in FIG. 2. Exemplarily, the functional requirements 212.1 of a system 200 may be analyzed via techniques such as PHA, preliminary hazard analysis, C-FMECA, criticality failure modes and effects (impacts) analysis, FTA, fault tree analysis, CCA, cremated cooper arsenate safety, FHA, etc. The data requirements 212.2 of a system 200 may be analyzed via a technique such as HAZOP, hazard and operability study. The interface requirements 212.3 of a system may be analyzed via a technique such as interface FMECA 214.3. The results of the analysis are provided to a safety analysis module 210 that interprets the results in view of the indicated hazards 216 and risks 218. As indicated in the figure, hazards are interpreted at least via condition, assumption, constrains 216.1, failure cause 216.2, failure modes 216.3, failure effects 216.4, countermeasures 216.5, etc. The risks 218 are interpreted via their probability 218.1, severity 218.2, non-detection probability 218.3, safety integrity level 218.4, etc.

As it may be observed in FIG. 2 based on the complete functional requirements that are identified in the sequence-based specification, a systematic safety analysis can be performed. FIG. 2 illustrates the correlation between the different types of requirements 206 and the corresponding safety analysis techniques 214.1 to 214.5.

As shown in FIG. 2, C-FMECA is required for single requirements failures with their hazardous conditions, assumptions, and constrains that cause the system to run into hazardous states. These conditions may be derived for example from domain-specified standards such as ISO 26262, that specify environmental and operational conditions for the automobile domain. PHA, preliminary hazard analysis, may be used for generating negated, fail safe, and negative, fail unsafe, requirements. FTA, Fault tree analysis, may be used for determining possible functional failure causality and failure rate. Sequence FMECA may be used for detecting the possible input sequences and possible dependent functions (requirements) failures. Data deviation (a deviation of HAZOP, Hazard and operability study) may be used for finding safety-critical data anomalies. An interface cause and effect classification, and general HAZOP may be used for exploring possible classifications of failure sources. After performing these type-based safety analysis techniques, the different types of requirements and their possible hazards and risks will be summarized. These inputs will be entered into positive, negative and alternative scenarios, respectively, as mentioned above regarding the plurality of elements characteristic for the system. A Finite state machine 208 of the analyzed system 200 will be generated based on the identified functional requirements and failure modes that are an essential part of the safety requirements.

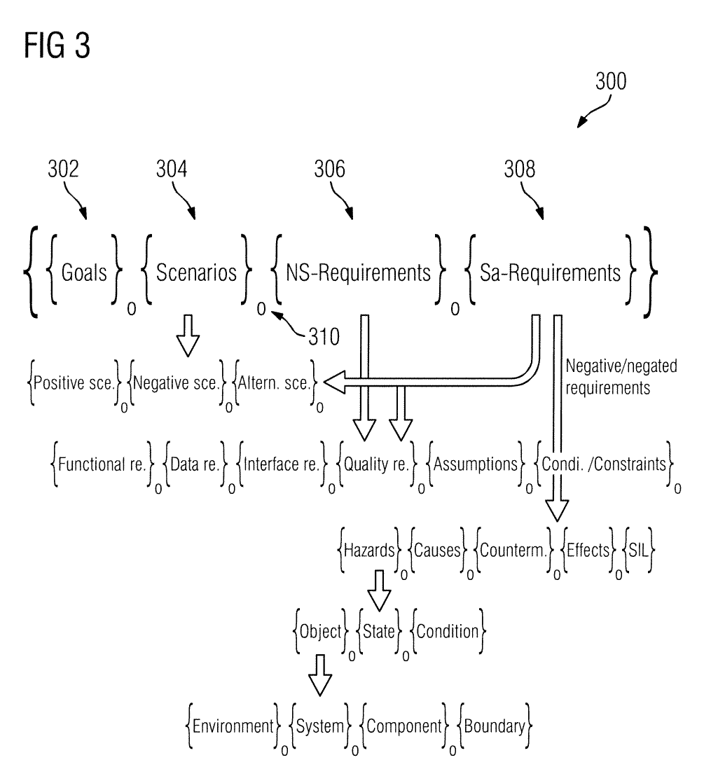

A structure 300 for defining a safety-oriented requirements specification for a technical system obtained via the requirements and safety analysis techniques discussed above combines all the identifiable elements of the technical system of the complete safety-oriented requirements (including the desired and undesired requirements). Such a structure 300 is shown in FIG. 3.

This structure 300 defines the safety-related items to be identified. The associated grammar (as is shown in FIG. 1) defines and specifies the general structure syntactically. This general structure 300 is the proof of completeness of the desired and undesired requirements. Safety-oriented requirements as identified in some embodiments allow for the identification of and to specify both the functional requirements (desirable requirements) as well as the safety-critical requirements (not desirable requirements).

The structure 300 shown in FIG. 3 exhibits four main elements: objectives (goals) 302, scenario 304, functional requirements 306 and safety-critical requirements 308 (safety requirements). The operator 310 appearing in the figure in multiple instances is an operator introduced via the grammar of FIG. 1. The scenario element 304 combines the functional 306 and safety-critical 308 requirements. The identified functional requirements 306 provide positive scenarios and thus a description of the expected behavior of the system. Hazards 216 and risks 218 are essential elements of the negative scenarios. Countermeasures that are identified by safety analysis (as described prior in connection with FIG. 2), are the alternative scenarios (also referred to as negated requirements).

A hazard 216 is defined as a condition or set of conditions of a system (or object) which, together with other conditions in the area of the system (or object) inevitably result in an error state, for example lead to an accident.

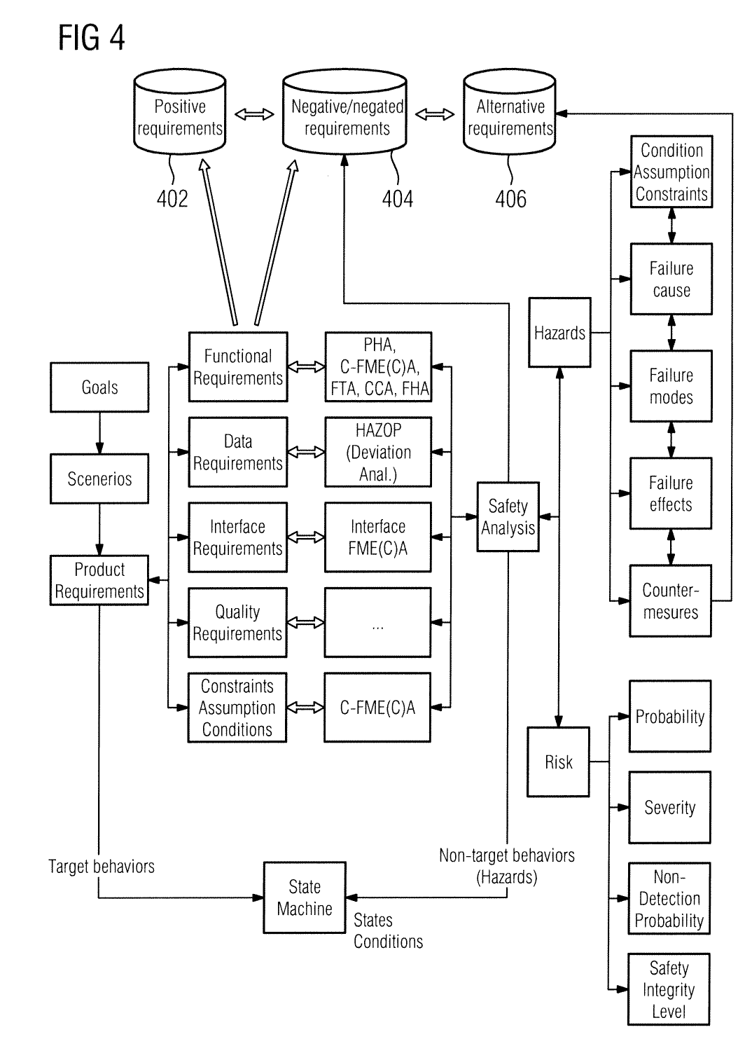

Referring now to the illustration of FIG. 4, FIG. 4 is a schematic representation of a flow chart of a SafeSBS (safety oriented sequence based specification).

The representation provided in FIG. 4 is the same representation provided earlier in FIG. 2, with several added elements. In addition to the elements discussed earlier in connection with FIG. 2, FIG. 4 represents as well a plurality of positive requirements 402, a plurality of negative requirements 404, and a plurality of alternative requirements 406.

As it may be observed in FIG. 4 the performance of a complete identification of the technical system requirements provides information regarding the technical system positive requirements and negative requirements. The negative requirements of the system may as well be identified base don the completed results of the safety analysis. The alternative requirements for the technical system may be identified based on the identified countermeasures to the identified hazards. The identified positive requirements, negative requirements and alternative requirement are included in a safety oriented sequence based specification generated via the editor. In safeSBS (safety oriented sequence based specification, additional operators are provided for performing the above mentioned safety analysis according to the types of requirements. The results of the safety analysis will be linked to their functional requirements. A finite state machine 208 will be generated, consisting of both normal states and hazardous states of the system. A failure mode denotes a safety critical state.

The functional and safety requirements are therefore specified into an intuitive form, such as a finite state machine, and can be transferred into a text based HTML specification. The risks that are identified during the safety analysis can be used or converted into transition probabilities for safety oriented statistical testing.

Considering for example a car window control unit, its functional requirements may be specified as follows: the movement of the window is controlled by the buttons in the car doors or by CAN messages: a window movement can either continue as long as the corresponding element stimulus is applied, or until the window is completely opened or closed; when a window is to be closed, there will always be a check of whether an obstacle is interfering with the window movement. If so, the closing procedure will be interrupted and the window will be fully opened, and raising and lowering the windows of the car needs to take into account child-proof mechanisms.

Based on these functional requirements, a preliminary safety analysis can be performed. The identified critical states, or failure modes, and the corresponding conditions are identified and summarized in a finite state machine. The essential elements such as functional description, data, input, output, interface, and safety requirements including hazards and risks will be identified and saved in the safety oriented sequence based specification.

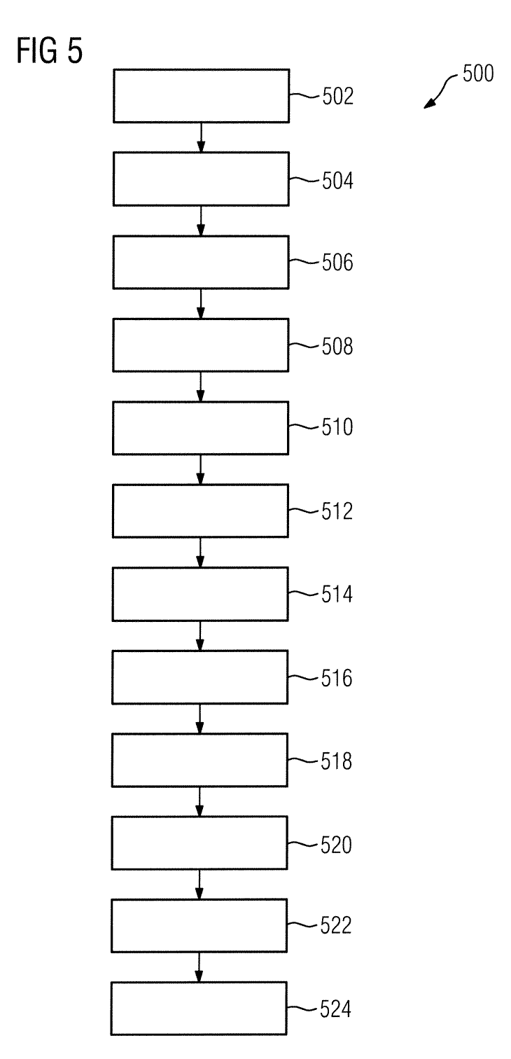

A method for defining a safety-oriented requirements specification for a technical system in accordance to an embodiment is described in the following with the aid of a workflow, with the aid of a method flowchart as shown in FIG. 5.

A method 500 for defining a safety-oriented requirements specification for a technical system, in accordance to an embodiment, comprises:

Step 502 of carrying out a normal safety-based-specification-Process (SBS): As shown in FIG. 2, the functional requirements of a technical system are subdivided in four main categories: functional requirements 212.1, data requirements 212.2, interface requirements 212.3 and non-functional requirements 212.4. Although the non-functional requirements are not described below in connection with the exemplary embodiment of the method, an extension of the method to include as well the non functional requirements of the technical system is as well envisioned to be comprised with the scope of various embodiments. For the purposes of the following discussion, the functional requirements 212.1, data requirements 212.2 and the interface requirements 212.3 are be considered as the main elements of the product/functional requirements for the technical system. As mentioned, these functional requirements are identified in the implementation of an already known SBS process.

The implementation of an SBS process leads to the complete characterization for the functional requirements of the technical system in terms of functional, data and interface specifications, due to the safe iteration performed through all possible sequences. During an SBS process, an enumeration of all possible sequences that are occurring in the system is taking place in order to identify all the desired functional requirements. Based on this sequence an enumeration of all positive (desired) behavior of the system is identified. In the step of performing the normal SBS process can be derived or identified the possible system boundaries, inputs to the system (stimuli), the response of the system (depending on the stimulus, if necessary, or depending on the predicates and the system state) and conditions under which the system reacts to a stimulus with a particular response. From all these elements, the actual enumeration (called a “sequence-based enumeration”) is created. The enumeration is a complete sequence of processes in the system until the system has no new reactions or new system states are not attained to incoming stimuli could be identified. The summary resulting from the canonical enumeration generated sequences (canonical-sequence analysis) are the unique legal system states. Values of state variables are mapping these states.

Step 504 of performing a sequence-based risk analysis, the identification of safety-critical sequences, the identification of counter measures (also called safety requirements, countermeasures or negative requirements or negated requirements) and the generation of state machines with all canonical (single, have no equivalent sequences) safety-critical sequences or states. In summary in this step, sequence-based hazards are being found. This sequence-based qualitative and quantitative risk analysis can be performed either directly from the enumeration of the negative requirements identified, or via a mapping function, based on appropriate risk analysis, such as Conditional FMECA (that identifies negated requirements). A Conditional FMEA Editor (C-FMEA-editor, FMECA—Failure mode, effects, and criticality analysis) may be employed for this purpose. In this step, first the logic error, or the sequence errors that should not happen at all in the system is identified. However, all the single functional functions are desired to be identified. The C-FMECA editor ensures that the risks of individual functions and the countermeasures (negated requirements) are identified. The identified failure modes (failure modes) are considered as dangerous states of the system and can be further used for generating the state machine. To this end, the above-mentioned conditions and assumptions are used. This analysis is performed based on the functional requirements imported into the C-FMEA Editor. The functional requirements were identified in the previous step of the SBS process, but can also be imported if they are already present.

Further still, other risk analysis methods (such as data variance analysis and interface FMECA) are carried out in this step. In some embodiments, therefore already in the requirements identification phase is included a combination of desired and undesired behavior in the state machine. The state machine then contains both the desired conditions and the safety-critical states, which are identified based on risk (hazard) analysis techniques and the sequence-based specification.

Step 506 of consideration of countermeasures in the generated state machine to eliminate the safety-critical states and to find links to other non-critical conditions, when the countermeasures are included in the state machine. In other words in this step is examined whether the countermeasures found in the previous step eliminate the safety-critical states. If this is the case, then these safety-critical states from the state machines are removed. If a state is not eliminated, it should be specially marked, and can continue to be considered in this step, whether the imported measures can lead to new critical conditions.

Step 508 that consists of the recordation of safety-critical requirements: the countermeasures are included in the Safe-editor and they will be recorded in the safety-oriented sequence-based specification system, Safe SBS system, exemplarily in an HTML file.

Step 510 of creating a reduced state machine representation based on functional requirements and the safety-critical requirements, in which the safety-critical states or the safety-critical transitions are no longer present, as these, due to the countermeasures identified by the system, are no longer reachable.

Step 512 of exporting the identified functional requirements to the C-FMEA-editor to find the failure modes and the countermeasures. This action is automatically included in the Safe-SBSEditor.

Step 514 of exporting the identified data (inputs, responses, and state variables) to the data deviation editor to find the deviations or hazards and countermeasures. The countermeasures can be automatically included in the safe-SBSEditor. The data-deviation analysis editor is to ensure that the hazards of the deviations of the data and the countermeasures (negated requirements) are identified. The identified hazards are based on the related functional requirements represented as dangerous conditions in the state machine. This analysis is based on identified data (Stimuli/inputs, Responses/outputs, and state variables identified in the construction of state machines in the SBS).

Step 516 of exporting the identified interfaces (interfaces, or system boundaries) to the interface editor to find the failure modes and corrective action with respect to the interface. The action is automatically included in the Safe-SBSEditor. The interface editor, which can be referred to as Interface FMECA serves to ensure that the hazards and failure modes with respect to the interfaces (referred to as SBS system boundary) and the countermeasures (the negated requirements) can be identified. The identified hazards are based on the related functional requirements continued to be used as dangerous conditions in the state machine. This analysis, as already mentioned, is performed based of the identified interfaces (system boundaries).

In summary, in steps 512, 514, and 516, the identified functions, data, interface and information regarding system behavior (exemplarily, sequences of stimuli, plus responses and states) are each exported to different editors, namely to the C-FMECA editor to identify the error and the safety requirements, to the data analysis editor (Data Deviation editor) to identify the data variance and safety requirements (as before the counter-measures) to determine and record the interface FMECA editor (interface analysis editor) to the possible consequences of the interface defects and then identify the safety requirements (countermeasures).

Via the above referenced steps the entire system combined is analyzed. This applies both to individual requirements/functions, but also to the data and the interfaces, since this data is exchanged via interfaces between different functions.

Step 518 in which the above identified failure modes, or the hazards are recorded and displayed as additional states in the reduced state machine (which was generated in step 510). The state machine combines both the desired behavior and unwanted behavior.

Step 520 in which a quantitative analysis of safety is performed regarding the system, in a sequence similar to the steps 502 to 518: While the sequence of steps previously discussed represents a qualitative analysis of system safety, step 520 proposes to follow with a quantitative analysis of the system safety. For example, via the risk values of the identified hazards, it is possible to determine how often certain hazards may occur and what is the level of consequence from these hazards.

Step 522 that identifies, for example with the same safety analysis editors, such as C-FMECA editor, but with a focus on determining the risk values, the probabilities of the hazards, the level of the consequence, and the risk values (Safety Integrity Level SIL), and

Step 524 wherein the functions are prioritized according to risk levels, and this prioritization can be used as well for other decisions, such as the resource planning of a project, and thus to meet project goals.

Therefore to summarize, a method 500 for defining a safety-oriented requirements specification for a technical system in accordance with various embodiments comprises, as illustrated in FIG. 5, at least the steps of carrying out a safety based specification identification process for the technical system, performing a sequence based qualitative risk analysis to identify a plurality of safety critical states for the technical system, partially eliminating safety critical states of the identified plurality of safety critical states, recording a plurality of safety critical requirements for the technical system by a system state machine, creating a reduced state machine based on a plurality of technical system functional requirements and the recorded plurality of safety critical requirements, finding a plurality of failure modes and a first plurality of countermeasures, finding a plurality of data deviations and a second plurality of countermeasures, finding a plurality of failure modes and a plurality of corresponding corrective actions with respect to a technical system interface, displaying information regarding the identified plurality of failure modes, performing a quantitative safety analysis regarding the technical system, identifying a plurality of risk values, and prioritizing functions in the safety-oriented requirements specification for a technical system according to the identified plurality of risk values.

From the workflow 500 is clear that, compared to the identification for the system of desired states using the SBS, in some embodiments, a number of further steps are taken which ensure that not only the desirable requirements are found in full, but also the undesirable requirements are found in full. Various embodiments perform a safety critical analysis of the system with all its scenarios, both desirable and undesirable.

Various embodiments therefore provide the safety-oriented sequence-based specification additional options (such as the C-FMECA Editor, the Data Deviation editor and the interface FMECA editor) to which the above-mentioned safety analysis based on the type of the requirements are identified. The results of this safety analysis can be combined in the procedure referred to their functional requirements.

As a consequence of performing the sequence of steps of the method according to various embodiments, a state machine is generated, which records both normal conditions and critical conditions (hazardous states) for the system, representing a failure mode means for safety-critical failure states.

Referring again to the illustration of FIG. 5 the plurality of requirements 212 may be negated as alternative requirements or countermeasures formed based on the safety analysis. Although not shown in the figure, its possible to link in the diagram different safety editor displays with the different demands on the system. Such a representation permits linking both the functional requirements and the safety requirements in an intuitive form, such as a finite state machine, and can for example be converted into a text-based HTML specification. The risks are identified during the safety analysis (in steps 520, 522, and 524 of the above referenced method 500) and transition probabilities are converted to safety-oriented statistical testing.

In addition to the used C-FMECA editor, data deviation editor and interface FMECA editor and other safety analysis techniques may be used for the implementation of the method 500.

As already mentioned, C-FMECA can be used for single requirement/function failure with their critical conditions, assumptions and limitations that cause the system to run in a critical state. These conditions may be defined for example in the domain-specified standards, such as ISO 26262 in the form of environmentally based and application-based conditions for the automotive domain. A PHA (Preliminary Hazard Analysis) can be used to identify the negative and negated the requirements. An FTA (Fault Tree Analysis) can be used to determine the possible probabilities for functional failure and a failure rate and determine the causal relationships between failure modes and between failure reasons.

Sequence FMECA can be used to different possible input sequences and possible dependent functions (requirements) to find failures. The data deviation editor that is a modification of the HAZOP (Hazard and Operability Study), may be used to find critical data anomalies. The interface FMECA editor can be used to analyze interface failure. Furthermore, a CCA (Cause and Consequence Analysis) may be used to find possible causes and classify their effects and to identify their dependencies. Furthermore, a standard HAZOP are used to divide failure reason into possible classifications, among others.

As with the described C-FMECA editor, the interface FMECA editor and the data deviation editor can also be found here for various types of requirements, and their potential hazards and risks are identified and summarized. These results are input to the positive, negative, and alternative scenarios, which are shown and discussed at least in connection with FIG. 3.

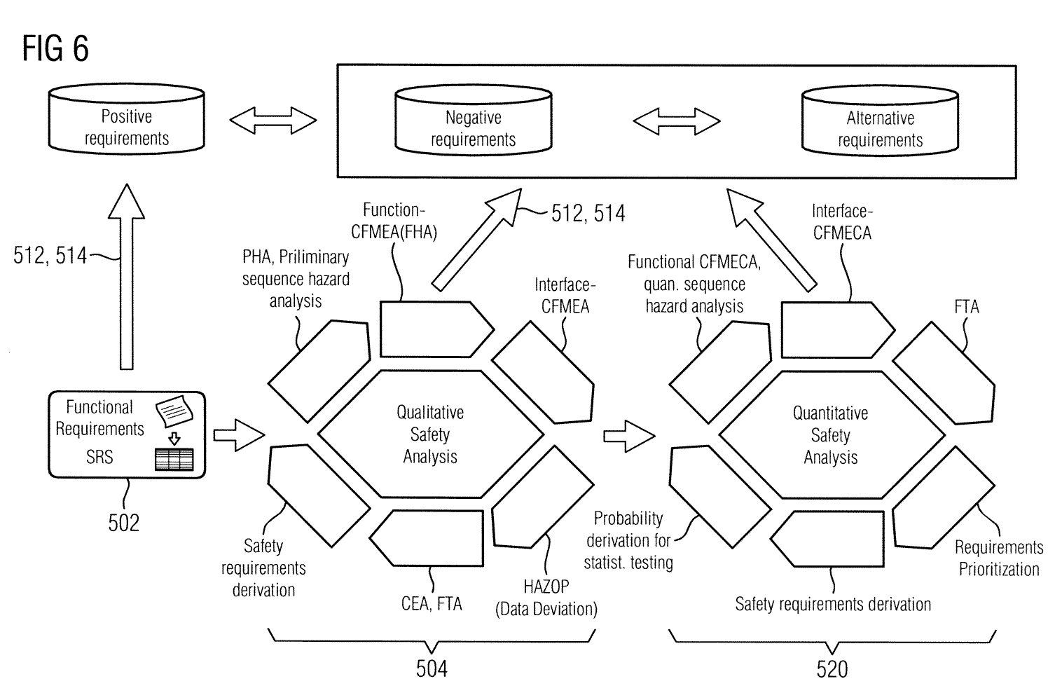

FIG. 6 is an alternative graphical representation of a workflow for obtaining a safety-oriented requirements specification for a technical system. The users or the safety experts can first perform a qualitative safety analysis iteratively, based on the identified desired functions or requirements (specifications). Further, a quantitative safety analysis is performed iteratively to identify the risk values. Both the qualitative and quantitative analyses use the Safe-SBSEditor, and the tool chain of the SafeRE, but with different focus. The qualitative analysis focuses on the hazards of the system (such as C-FMEA), the quantitative analysis focuses on the risk values of identified hazards (such as C-FMECA). The workflow illustrated by FIG. 6 shows a procedure that a safety expert could follow, an expert that uses this tool to perform the safety analyses, and to identify the safety-oriented requirements, with a clear goal, namely at first the determination of the qualitative requirements, and secondly the determination of the quantitative requirements.

In summary some advantageous aspects of various embodiments will be explained. One objective of some embodiments is to avoid safety risks early and proactively. The embodiments can therefore identify a complete set of safety requirements, as the functional requirements are complete and the required safety analysis on different parts of the functional requirements will be carried out systematically. In particular, for different functional requirements of various safety analysis techniques are performed, which are adapted to the various functional requirements. Simultaneously using this approach, the desired and undesired requirements are described, as early in the requirements engineering phase. This approach addresses the gaps of safety-critical specification development both in theory and in practice, whereas up to know there have been no successful approaches to obtain the complete set of safety-critical requirements (in terms of complete functional requirements, plus the systematic safety analysis). With the presented approach and a software performing the method, requirements engineers and safety experts are able to identify complete safety-related requirements (both desired and non-desired system behavior) and at the same time, visualize, and optimize those.

The approach according to various embodiments consists of specific steps that may be implanted via a workflow computer program product. Among others, the present approach differs from approaches already know in the art by the fact that a Statebox specification of desired and undesired safety-critical conditions is made in accordance with various embodiments, versus in the solutions proposed in the art, was created only a specification of desired states Statebox. Furthermore, various embodiments propose at least two new safety analysis techniques, namely sequence-based hazard (risk) analysis, and the C-FME(C)A analysis, and three analysis editors, namely C-FMECA Editor, the Data Analysis Deviation editor and interface FMECA Editor that are added already during the in the requirements gathering phase to identify undesirable states of the system. To this end, the identified functional descriptions are exported as objects of analysis in the C-FMECA editor and analyzed there. The identified data (at first inputs and outputs) are exported to the data Deviation editor and analyzed there. The identified interface (interfaces or System Boundaries) are exported to the FMECA Interface Editor and analyzed there.

Furthermore, the approach of various embodiments further differs from the approaches of the art that after the analyzed failure modes are added using an expanded role, “Function Mapping” the state machine is added as a safety-critical condition.

As already mentioned, various embodiments propose the use of a reduced version of the state machine, which was reduced in the sequence-based risk analysis, as the safety-critical states have been, through the use of countermeasures as far as possible, eliminated. In some embodiments, therefore, a qualitative, systematic scenario-based (a unique sequence is a scenario in various embodiments) safety analysis is performed. In accordance with various embodiments also a quantitative safety analysis may be carried out. The identified failure modes or hazards can thus be described with risk values relating to the likelihood and level of consequences of the risks or costs. The functional requirements can be prioritized on the basis of such risk values and may be easily used for further decisions.

Thus, as mentioned earlier, not only desired, but also the non-desired behavior of the system is identified with the same risk values. According to some embodiments, further, the C-FMECA analysis techniques are an extension of the FMECA analysis technology. Compared to the analysis techniques used during FMECA, a C-FMECA table can be expanded to include additional columns, for example, the column “Condition”, “Assumption” and “constraints”. This extended FMEA (the C-FMEA) is used to identify, the directly involved safety critical factors, explicitly. These provide the inputs to trigger the transitions (transitions) in the state machine. This is an important step towards the construction of the state machine for safety-critical systems, step that was previously not considered. The use of C-FMECA (Conditional FMECA) enables a complete and safe construction of state machines for safety critical systems.

In summary, some embodiments provide a systematic, comprehensive, effective, standardized and intuitive approach to gathering safety requirements based on complete functional requirements. Various embodiments are characterized by one or more of the following:

a grammar, which represents not only the structure but also relationships between the different structural system elements;
a comprehensive and systematic finding and analyzing tool of safety-critical elements, based on safety analysis techniques (such as the C-FMECA-safety analysis technique, the data deviation analysis technique and interface FMECA analysis technique);
an assurance with respect to the completeness of the analysis, based on the complete functional requirements;
a specification and a representation of the safety-oriented requirements in an intuitive way, in the form of state machine-based requirements;
support of safety-assurance activities in the various stages of development, for example, by risk-based testing.

As mentioned above, various embodiments may as well be implemented via a computer software that is capable of performing the method. Therefore, in accordance with a further embodiment is proposed a computer program product capable of defining a safety-oriented requirements specification for a technical system.

As will be appreciated by one skilled in the art, the present disclosure may be embodied at least as a method, or computer program product. Accordingly, the present disclosure may take the form of an entirely hardware embodiment, an entirely software embodiment (including firmware, resident software, micro-code, etc.) or an embodiment combining software and hardware aspects.

The present disclosure is herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Therefore, in accordance with a further embodiment, is proposed a computer program product capable of providing a safety-oriented requirements specification for a technical system. Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A computer program product in accordance with various embodiments comprises a tangible computer usable medium including a computer usable program code for providing a safety-oriented requirements specification for a technical system, the computer usable program code for carrying out a safety based specification identification process for the technical system, performing a sequence based qualitative risk analysis to identify a plurality of safety critical states for the technical system, partially eliminating safety critical states of the identified plurality of safety critical states, recording a plurality of safety critical requirements for the technical system by a system state machine, creating a reduced state machine based on a plurality of technical system functional requirements and the recorded plurality of safety critical requirements, finding a plurality of failure modes and a first plurality of countermeasures, finding a plurality of data deviations and a second plurality of countermeasures, finding a plurality of failure modes and a plurality of corresponding corrective actions with respect to a technical system interface, displaying information regarding the identified plurality of failure modes, performing a quantitative safety analysis regarding the technical system, identifying a plurality of risk values, and prioritizing functions in the safety-oriented requirements specification for a technical system according to the identified plurality of risk values.

An exemplary application of various embodiments is discussed bellow in connection with the study of an operational control unit of a train door and of its safety requirements.

In accordance with the method, in an initial step of carrying out a normal safety-based-specification-Process (SBS) the functional requirements of the technical system are subdivided in four main categories: functional requirements, data requirements, interface requirements and non-functional requirements. Although the non-functional requirements (except for safety requirements, such as performance requirements, usability requirements, etc.) are not described in connection with the exemplary embodiment of the method, an extension of the method to include as well the non functional requirements of the technical system is as well envisioned to be comprised with the scope of various embodiments.

For the purposes of the following discussion, the functional requirements, the data requirements and the interface requirements are considered as the main elements of the product/functional requirements for the technical system. As mentioned, these functional requirements are identified in the implementation of an already known SBS process.

The implementation of an SBS process leads to the complete identification for the functional requirements of the technical system in terms of functional, data and interface specifications, due to the effective iteration performed through all possible sequences. During an SBS process, an enumeration of all possible sequences that are occurring in the system will be performed in order to identify all the desired functional requirements. Based on these sequences, sequences of all positive (desired) behavior of the system are identified. In the step of performing the normal SBS process the possible system boundaries are indentified, the inputs to the system (stimuli), the response of the system (depending on the stimulus, if necessary, or depending on the predicates and the system state) and conditions under which the system reacts to a stimulus with a particular response, will also be identified. From all these elements, the actual enumeration (called a “sequence-based enumeration”) is performed. The enumeration is a complete set of sequence of in the system until the system has no new reactions or new system states are not attained to incoming stimuli could be identified. The summary resulting from the canonical enumeration generated sequences (canonical-sequence analysis) are the unique legal system states. Values of state variables are mapping these states.

Therefore, for a control unit of door of a train, as requirements must the following possible requirements be identified: system boundaries, stimuli, representing inputs to the system, responses, representing outputs of the system depending upon the stimulus of the system, where applicable, the predicates and the system state, predicates, representing the condition sunder which when the system receives certain stimulus reacts with a particular response.

For all the elements, an actual enumeration is created. By enumeration is understood a complete set of sequences in the system, performed till the system exhibits no new reactions or no new system states are obtained to new response. The generated canonical sequence analysis provides legal, correct and unique system states including state variable that are mapped to those states.

### Requirement Start:

Description: TSP (operational control unit in English as mentioned before) must be started after the direct actuation of the key in the cockpit of the train.

Derived system boundary: ignition at the start of the train;
Derived stimulus: start;
Derived Response: TSP started;
Derived predicates: not available.

Requirement Entry: “Turn on the air pressure of the foot step”.

Description: TSP must be able to receive the entry “turn on air pressure” from the footstep air-pressure sensor. The foot step air-pressure must be turned on.

Derives system boundary: actuator;
Derived stimulus: foot step air-pressure turned on;
Derived Response: foot step air-pressure on;
Derived predicate: not available.

Related sequence: Start→foot step air pressure turned on.

Requirement Entry: “foot step air-pressure switched off”.

Description: TSP must be able to take the entry “foot step air-pressure switched off” from the footstep air-pressure sensor. The foot step air-pressure must be turned off.

Derives system boundary: actuator;
Derived stimulus: foot step air-pressure turned on;
Derived Response: foot step air-pressure on;
Derived predicate: not available.

Related sequence: Start→foot step air pressure turned on→foot step air-pressure switched off.

Derived State Variables:

TSP: possible values: not started, or started;
Foot step air-supplying device values: on, off.

CSAs (Canonical Sequence Analysis):

TSP not started, foot step air supplying device off;
TSP started: TSP foot step air supplying device on;
TSP started: TSP foot step air supplying device off;

The information derived above may be inserted and processed via a normal SBSEditor. For example, Estrela, a SBSEditor in JAVA Edition, a dedicated software that comprises the following tabs: Requirement, System boundary, Stimulus, Response, Named response, Predicate, Sequence Enumeration, State variable, Canonical sequence analysis, state box, function mapping, input mapping, output mapping.

In accordance with various embodiments in a subsequent step a sequence-based risk analysis is performed, the identification of safety-critical sequences, the identification of counter measures (also called safety requirements, countermeasures or negative requirements or negated requirements) and the generation of state machines with all canonical (single, have no equivalent sequences) safety-critical sequences or states, will be identified. In summary in this step, sequence-based hazards are being found.

This sequence-based qualitative and quantitative risk analysis can be performed either directly from the enumeration of the negative requirements identified, or via a mapping function, based on appropriate risk analysis, such as Conditional FMECA (that identifies negated requirements). A Conditional FMEA Editor (C-FMEA-editor, FMECA—Failure mode, effects, and criticality analysis) may be employed for this purpose.

In this step, first the logic error, or the sequence errors that should not happen at all in the system is identified. However, all the single functional functions are desired to be identified. The C-FMECA editor ensures that the risks of individual functions and the countermeasures (negated requirements) are identified. The identified failure modes (failure modes) are considered as dangerous states of the system and can be further used for generating the state machine. To this end, the above-mentioned conditions and assumptions are used. This analysis is performed based on the functional requirements imported into the C-FMEA Editor. The functional requirements were identified in the previous step of the SBS process, but can also be imported if they are already present.

Further still, other risk analysis methods (such as data deviation analysis and interface FMECA) are carried out in this step. In some embodiments, as mentioned already in the requirements identification phase, a combination of desired and undesired behavior in the state machine will be generated and presented. The state machine then contains both the desired conditions and the safety-critical states, which are identified based on the sequence-based specification and type-based risk (hazard) analysis techniques.

Referring again to the exemplary system that controls the functioning of a train door, the results of the safety analysis may be summarized as: the stimulus “foot step air-pressure switched off” is safety critical, and qualifies to be denominated as “very critical”, therefore specific, elevated controls of this stimulus are necessary. The stimulus will be entered in the dedicated software as “very critical”, and based on the entry countermeasures will be identified. As a result the applicable safety countermeasures will be identified and documented, this step is facilitated by the safety element and the including functionalities, in the enumeration tab upon entry in the dedicated software of the applicable countermeasures. The created safety requirements may be exported from the software as an html document. A graphical representation or they may be displayed in graphical form by the state machine via an integrated yFile (yED) graph editor.

The above enumerated steps are followed, in accordance with various embodiments, specifically regarding the example of controlling the functioning of an train door by the elimination of the safety-critical states and to find links to other non-critical conditions, when the countermeasures are considered in constructing the state machine. In other words in this step is examined whether the countermeasures found in the previous step eliminate the safety-critical states. If this is the case, then these safety-critical states from the state machines are removed. If a state is not eliminated, it should be specially marked, and can continue to be considered in this step, whether the imported measures can lead to new critical conditions.

In a subsequent step the safety-critical requirements are recorded in the safeSBS editor, exemplarily in an html file. The countermeasures are included in the Safe-editor and they will be recorded in the safety-oriented sequence-based specification system, Safe SBS system, exemplarily in an HTML file.

An exemplary html file records: a condition, length, prefix, stimulus, predicates, responses, legal sequences, safety critical sequences, equivalence, and requirements trace.

In the following step a reduced state machine representation is created based on functional requirements and the safety-critical requirements, in which the safety-critical states or the safety-critical transitions are no longer present, as these, due to the countermeasures identified by the system, are no longer reachable.

The identified functional requirements are exported to the C-FMEA-editor to find the failure modes and the countermeasures. This action is automatically included in the Safe-SBSEditor.

The identified data (inputs, responses, and state variables) is exported to the data deviation editor to find the deviations or hazards and countermeasures. The countermeasures can be automatically included in the safe-SBSEditor. The data-deviation analysis editor ensures that the hazards of the deviations of the data and the countermeasures are identified. The identified hazards are based on the related functional requirements represented as dangerous conditions in the state machine. This analysis is based on identified data identified in the construction of state machines in the SBS. This state machine is the reduced state machine, which the countermeasures are considered, the safety-critical states for example the logic error are eliminated. This means that the data deviations are presented as new safety-critical states, in the reduced state machine.

The action is automatically included in the Safe-SBSEditor. The interface editor, which can be referred to as Interface FMECA serves to ensure that the hazards and failure modes with respect to the interfaces (referred to as SBS system boundary) and the countermeasures (the negated requirements) can be identified. The identified hazards are based on the related functional requirements continued to be used as dangerous conditions in the state machine. This analysis, as already mentioned, is performed based of the identified interfaces (system boundaries).

The above identified failure modes, or the hazards, are recorded and displayed as additional states in the reduced state machine representation. The state machine combines both the desired behavior and unwanted behavior.

A quantitative analysis of safety is performed regarding the system. While the sequence of steps previously discussed represents a qualitative analysis of system safety, in this step a quantitative analysis of the system safety is performed. For example, the risk values of the identified hazards will be identified. It is necessary to determine how often certain hazards may occur and what is the level of consequences from these hazards. While employing the same safety analysis editors, such as C-FMECA editor, but with a focus on determining the risk values, the probabilities of the hazards, the level of the consequence, and the risk values (Safety Integrity Level SIL) are determined. Finally, the functions are prioritized according to risk levels, and this prioritization can be used as well for other decisions, such as the resource planning of a project, and thus to meet project goals.

Accordingly, the disclosed embodiments present a structure, an apparatus, a method and a computer program product for defining a safety-oriented requirements specification for a technical system. The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

In addition, the flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. An apparatus for providing a structure defining a safety-oriented requirements specification for a technical system, comprising:
means for gathering information regarding a plurality of elements characteristics of the technical system, and
means for, applying a grammar,
wherein the grammar is capable of defining syntactically the structure based on the plurality of elements characteristics of the technical system, and
wherein the grammar is capable of refining syntactically the safety-oriented requirements specification for the technical system.

2. The apparatus according to claim 1, wherein the technical system comprises both a plurality of functional characteristics and a plurality of safety requirements for the technical system.

3. The apparatus according to claim 2, wherein the technical system comprises at least one of technical system goals, technical system scenarios, technical system requirements, and technical system safety requirements.

4. The apparatus according to claim 3, wherein the technical system goals comprise both a plurality of functional goals and a plurality of non functional goals.

5. The apparatus according to claim 3, wherein the technical system scenarios comprise either one of a plurality of positive scenarios, a plurality of negative scenarios, and a plurality of alternative scenarios.

6. The apparatus according to claim 5, wherein for the development of the plurality of positive scenarios, a plurality of negative scenarios and a plurality of alternative scenarios both functional and safety requirements are included.

7. The apparatus according to claim 3, wherein the technical system requirements comprise at least one of technical system functional requirements, technical system data requirements, technical system interface requirements, technical system non-functional requirements, and assumptions regarding the technical system.

8. The apparatus according to claim 3, wherein the technical system safety requirements comprise at least one of a plurality of hazards, a plurality of causes, a plurality of impacts, a plurality of effects, and a safety integrity level.

9. The apparatus according to claim 8, wherein the plurality of hazards are derived at least from one of information provided regarding the technical system, the state of the technical system, and a condition of the technical system.

10. A method for providing a structure defining a safety-oriented requirements specification for a technical system, comprising:
gathering information regarding a plurality of elements characteristics of the technical system, and
applying a grammar,
wherein the grammar is capable of defining syntactically the structure based on the plurality of elements characteristics of the technical system, and
wherein the grammar is capable of refining syntactically the safety-oriented requirements specification for the technical system.

11-19. (canceled)
